(19) United States
(12) Patent Application Publication
(10) Pub. No.: US 2025/0096887 A1
(43) Pub. Date: Mar. 20, 2025

(54) WIRELESS COMMUNICATION APPARATUS AND STARTUP METHOD

(71) Applicant: NIPPON TELEGRAPH AND TELEPHONE CORPORATION, Tokyo (JP)

(72) Inventors: Kazumitsu SAKAMOTO, Musashino-shi (JP); Tomoya KAGEYAMA, Musashino-shi (JP); Yosuke FUJINO, Musashino-shi (JP); Daisuke GOTO, Musashino-shi (JP); Yasuyoshi KOJIMA, Musashino-shi (JP); Kiyohiko ITOKAWA, Musashino-shi (JP)

(73) Assignee: NIPPON TELEGRAPH AND TELEPHONE CORPORATION, Tokyo (JP)

(21) Appl. No.: 18/729,811

(22) PCT Filed: Jan. 20, 2022
(86) PCT No.: PCT/JP2022/001995

§ 371 Date: Jul. 17, 2024

(51) Int. Cl. H04B 7/185; H04W 52/02

(52) U.S. Cl. CPC H04B 7/18513; H04W 52/0235

(57) ABSTRACT

There is provided a wireless communication device in a wireless communication system including one or more communication devices installed on the ground and a moving wireless communication device, the wireless communication device including: an activation signal generation unit that generates an activation signal for activating the one or more communication devices; a distribution unit that distributes the activation signal generated by the activation signal generation unit; one or more frequency change application units that apply a frequency change to the activation signal distributed by the distribution unit; and a transmission unit that transmits an activation signal to which a frequency change is applied to the one or more frequency change application units.

### TECHNICAL FIELD

The present invention relates to a wireless communication device and an activation method.

### BACKGROUND ART

With the development of Internet of Things (IoT) technology, installing IoT terminals including various sensors in various places has been studied. The IoT terminals may be installed in places where it is difficult to install a base station, such as a buoy or a ship on the sea or a mountainous area. In view of this, a system has been proposed in which data collected by IoT terminals installed in various places is relayed to a base station installed on the ground via a relay device mounted on a low earth orbit satellite.

Since the IoT terminal is driven by the power supplied from batteries, it is necessary to operate the IoT terminal with power saving in order to extend the battery life. Therefore, in the satellite sensing platform, in order to realize the battery life of the IoT terminal in units of years, it is necessary for the IoT terminal to uplink transmit data when it detects that a low earth orbit satellite arrives in the sky. In order for an IoT terminal to detect that a low earth orbit satellite arrives in the sky, means for observing a downlink signal from the low earth orbit satellite to the ground as in the technology of Non Patent Literature 1 is considered (for example, refer to Non Patent Literature 1).

### CITATION LIST

### Non Patent Literature

Non Patent Literature 1: F. Shu, X. Zhang, T. Kondo, “Development of correlator model for differential VLB1 observations of satellites”, 2008 International Conference on Microwave and Millimeter Wave Technology, ICMMT2008 Proceedings, Vol. 1, pp. 443-446, April 2008.

### SUMMARY OF INVENTION

### Technical Problem

However, since the low earth orbit satellite moves at a high speed, an in-frame Doppler shift occurs in the downlink signal transmitted from the low earth orbit satellite. Therefore, there is a problem that the IoT terminal installed at the position where the Doppler shift exceeding the allowable range that can be demodulated occurs cannot demodulate the downlink signal and cannot be activated even when the reception level of the downlink signal is high. Such a problem occurs not only in a signal transmitted from a low earth orbit satellite but also in a signal transmitted from a wireless communication device that moves in the sky.

In view of the above circumstances, an object of the present invention is to provide a technology by which a communication device installed on the ground can be activated even when a Doppler shift occurs in a signal transmitted from a wireless communication device that moves in the sky.

### Solution to Problem

According to an aspect of the present invention, there is provided a wireless communication device in a wireless communication system including one or more communication devices installed on the ground and a moving wireless communication device, the wireless communication device including: an activation signal generation unit that generates an activation signal for activating the one or more communication devices; one or more frequency change application units that apply a frequency change to the activation signal generated by the activation signal generation unit; and a transmission unit that transmits an activation signal to which a frequency change is applied by the one or more frequency change application units.

According to another aspect of the present invention, there is provided an activation method performed by a wireless communication device in a wireless communication system including one or more communication devices installed on the ground and the moving wireless communication device, the activation method including: generating an activation signal for activating the one or more communication devices; applying a frequency change to the generated activation signal; and transmitting an activation signal to which a frequency change is applied.

### Advantageous Effects of Invention

According to the present invention, even when a Doppler shift occurs in a signal transmitted from a wireless communication device that moves in the sky, a communication device installed on the ground can be activated.

### BRIEF DESCRIPTION OF DRAWINGS

FIG. 1 is a view for describing an outline of a wireless communication system in the present invention.

FIG. 2 is a schematic diagram illustrating an in-frame Doppler shift caused by performing processing in the present invention and a state in a frame at the time of terminal station reception.

FIG. 3 is a schematic diagram illustrating an in-frame Doppler shift caused by performing processing in the present invention and a state in a frame at the time of terminal station reception.

FIG. 4 is a schematic diagram illustrating an in-frame Doppler shift caused by performing processing in the present invention and a state in a frame at the time of terminal station reception.

FIG. 5 is a schematic diagram illustrating an in-frame Doppler shift caused by performing processing in the present invention and a state in a frame at the time of terminal station reception.

FIG. 6 is a configuration diagram of a wireless communication system according to an embodiment.

FIG. 7 is a diagram illustrating an example of an application table according to the embodiment.

FIG. 8 is a sequence diagram illustrating a flow of activation processing in the terminal station performed by the wireless communication system according to the embodiment.

### DESCRIPTION OF EMBODIMENTS

Hereinafter, an embodiment of the present invention will be described with reference to the drawings.

### (Outline)

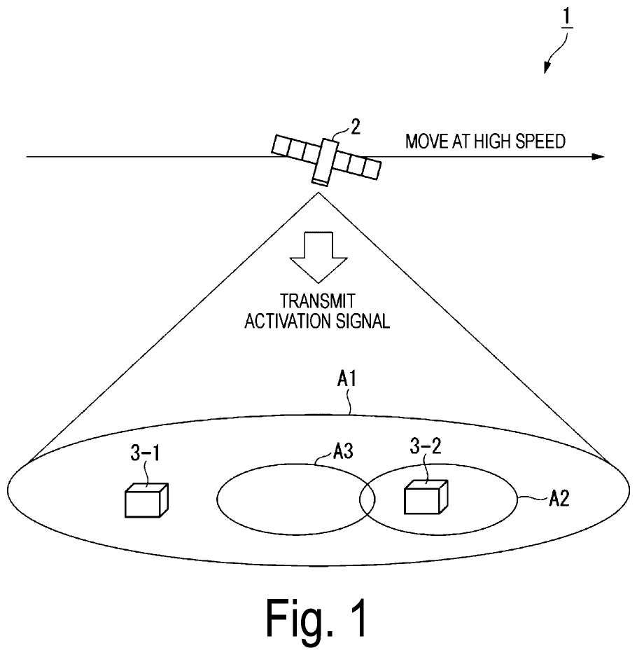

FIG. 1 is a diagram for describing an outline of a wireless communication system 1 in the present invention. As illustrated in FIG. 1, the wireless communication system 1 in the present invention includes at least a mobile relay station 2, and one or more terminal stations 3. FIG. 1 illustrates, as an example, a case where two terminal stations 3-1 to 3-2 are provided. The terminal station 3-1 and the terminal station 3-2 are disposed in different areas. For example, the terminal station 3-1 is disposed in an area A1, and the terminal station 3-2 is disposed in an area A2.

Since the mobile relay station 2 moves at a high speed, an in-frame Doppler shift occurs when an activation signal transmitted by the mobile relay station 2 is received by the terminal station 3 disposed in each area. The activation signal is a signal for activating the terminal station 3. When an in-frame Doppler shift occurs in the activation signal, some of the terminal stations 3 disposed in each area may not be able to demodulate and decode the activation signal. For example, even when the activation signal transmitted from the mobile relay station 2 is received by the terminal station 3-1 located in the area A1 and the terminal station 3-2 located in the area A2, different in-frame Doppler shifts occur in the activation signals received by each terminal station 3, and the activation signals may not be demodulated and decoded depending on the installation place of the terminal station 3.

Therefore, when transmitting the activation signal, the mobile relay station 2 according to the present invention multiplexes and transmits each activation signal to which an in-frame frequency change suitable for each area on the ground (for example, areas A1, A2, and A3 in FIG. 1) viewed from the mobile relay station 2 was applied. It is assumed that the in-frame frequency change suitable for each area is determined in advance based on the altitude of the mobile relay station 2 (more specifically, the moving speed of the mobile relay station 2 determined by the altitude), the downlink transmission frequency, and the position of the mobile relay station 2 and the area.

As more specific processing, the mobile relay station 2 distributes the activation signal, applies a frequency change suitable for each area to each distributed activation signal, and then synthesizes and transmits the activation signal. As a result, even when an in-frame Doppler shift occurs in the activation signal transmitted from the mobile relay station 2, the terminal station 3 can be activated.

For example, when the altitude of the mobile relay station 2 is 570 km and it is desired to activate the terminal station 3 in an area (In FIG. 1, an area A3) immediately below the mobile relay station 2 with an activation signal in the 400 MHz band, the mobile relay station 2 applies a frequency change of approximately 130 Hz/s to the activation signal and transmits the activation signal, and accordingly, the terminal station 3 can demodulate and decode the activation signal. Furthermore, in a case where it is desired to activate the terminal station 3 in an area at a distance of approximately 300 km from directly below the mobile relay station 2, the mobile relay station 2 applies a frequency change of approximately 90 Hz/s to the activation signal, and accordingly, the terminal station 3 can demodulate and decode the activation signal.

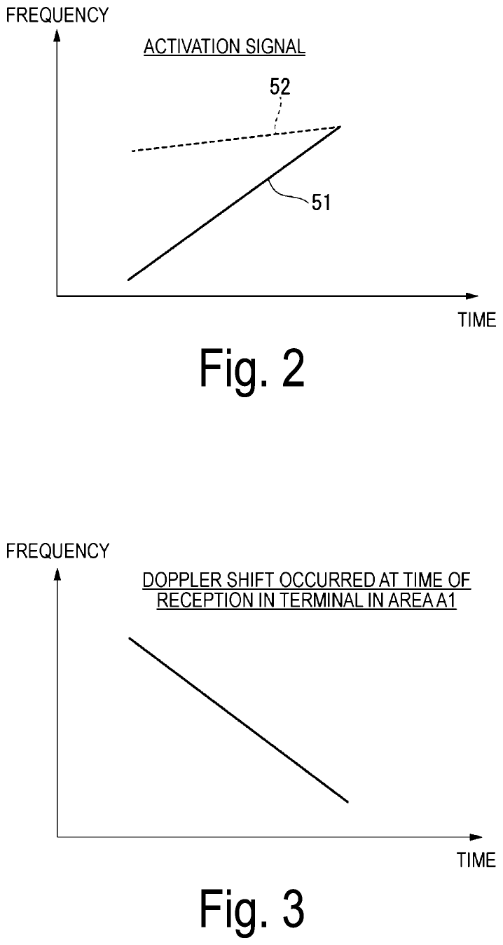

FIGS. 2 to 5 are schematic diagrams illustrating an in-frame Doppler shift caused by performing the processing in the present invention and a state in a frame at the time of the terminal station 3 reception. As illustrated in FIG. 2, it is assumed that the mobile relay station 2 transmits an activation signal obtained by synthesizing an activation signal 51 and an activation signal 52. The activation signal 51 represents a signal in which a value of a frequency change F1 is applied to the activation signal to activate the terminal station 3-1 disposed in the area A1, and the activation signal 52 represents a signal in which a value of a frequency change F2 is applied to the activation signal to activate the terminal station 3-2 disposed in the area A2. Here, the frequency changes F1 and F2 are frequency change values suitable for each area determined in advance based on the altitude of the mobile relay station 2 and the downlink transmission frequency.

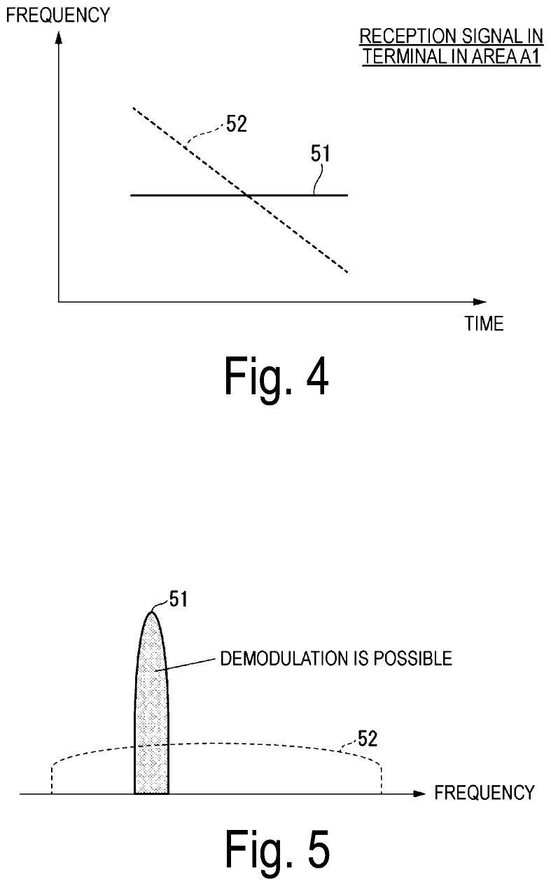

The Doppler shift as illustrated in FIG. 3 occurs in the activation signal received by the terminal station 3-1 disposed in the area A1. As a result, the activation signal at the time of reception in the terminal station 3-1 disposed in the area A1 is in the state illustrated in FIG. 4. FIG. 5 illustrates an example in which the example illustrated in FIG. 4 is viewed on the frequency axis. Although the activation signals to which different frequency changes are applied interfere with each other, due to the in-frame Doppler shift, only the activation signal 51 after application of the frequency change suitable for the area A1 is emphasized, and the activation signal 52 after application of other frequency changes is frequency-spread as illustrated in FIG. 5. Therefore, it can be seen that the activation signal 51 to which the value of the frequency change F1 is applied can be demodulated and decoded. As a result, the terminal station 3-1 can be activated.

In FIGS. 2 to 5, the terminal station 3-1 disposed in the area A1 has been mainly described, but the same applies to the terminal station 3-2 disposed in the area A2. For example, in the terminal station 3-2 disposed in the area A2, a Doppler shift different from the Doppler shift generated in the activation signal received by the terminal station 3-1 disposed in the area A1 occurs. In this case, in the activation signal at the time of reception in the terminal station 3-2 disposed in the area A2, the activation signal to which the frequency change F2 is applied is emphasized, and the activation signals 51 after the application of the other frequency changes are frequency-spread. Therefore, the activation signal 52 to which the value of the frequency change F2 is applied can be demodulated and decoded. As a result, the terminal station 3-2 can be activated.

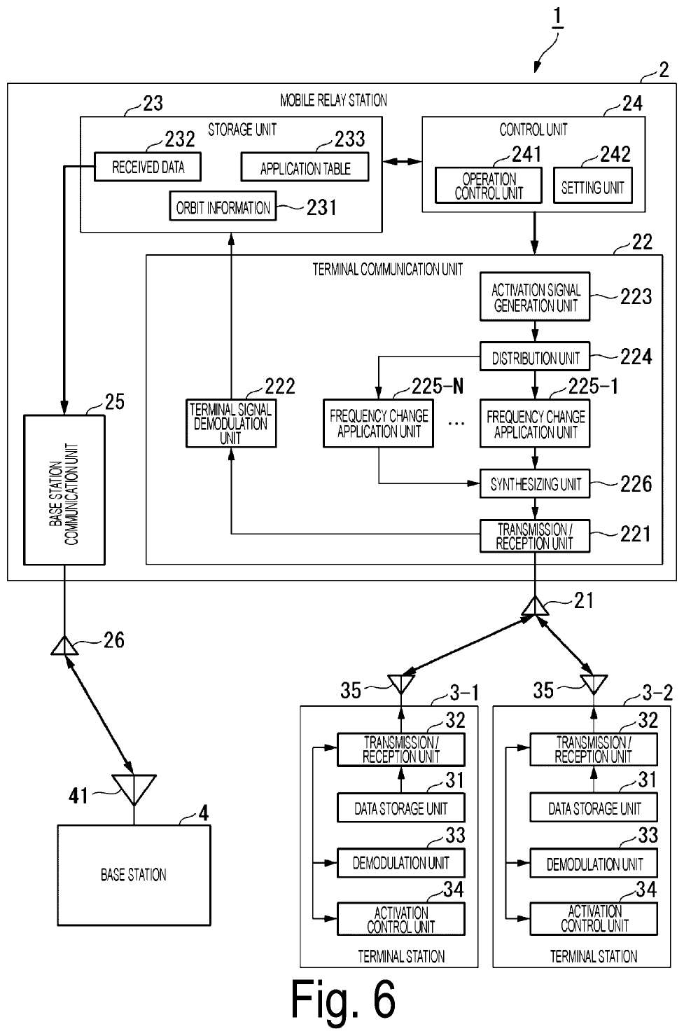

FIG. 6 is a configuration diagram of the wireless communication system 1 according to an embodiment. The wireless communication system 1 includes the mobile relay station 2, the one or more terminal stations 3, and a base station 4. The number of each of the mobile relay stations 2, the terminal stations 3, and the base stations 4 included in the wireless communication system 1 is randomly selected. It is assumed that the number of terminal stations 3 is large. FIG. 6 illustrates a case where the wireless communication system 1 includes two terminal stations 3-1 and 3-2. In the following description, when the terminal stations 3-1 and 3-2 are not particularly distinguished, the terminal stations 3-1 and 3-2 are simply referred to as terminal stations 3.

The mobile relay station 2 is an example of a wireless communication device which is mounted on a moving object and of which an area where communication is possible moves with the lapse of time. When reaching above the data collection area, the mobile relay station 2 transmits an activation signal for activating the terminal station 3. The data collection area is an area for collecting data acquired by the terminal station 3. The mobile relay station 2 determines, for example, whether or not the mobile relay station 2 has reached the sky above the data collection area based on orbit information of the mobile relay station 2 and time information.

The mobile relay station 2 of the present embodiment is provided in a low earth orbit (LEO) satellite. The LEO satellite has an altitude of 2000 km or less and travels through the sky around the earth in approximately 1.5 hours per orbit. The terminal station 3 and the base station 4 are installed on the earth such as on the ground or on the sea. Hereinafter, a wireless signal transmitted from the terminal station 3 to the mobile relay station 2 will be referred to as a terminal uplink signal, and a signal transmitted from the mobile relay station 2 to the terminal station 3 and the base station 4 will be referred to as a downlink signal.

Since the mobile relay station 2 mounted on the LEO satellite performs communication while moving at a high speed, a time during which each terminal station 3 or the base station 4 can communicate with the mobile relay station 2 is limited. Specifically, seen from the ground, the mobile relay station 2 passes through the sky in about several minutes. Therefore, the terminal station 3 collects and stores data such as environmental data detected by the sensor. The terminal station 3 transmits a terminal uplink signal in which the collected data is set at a timing at which communication with the mobile relay station 2 is possible. The mobile relay station 2 receives the terminal uplink signal transmitted from each of the plurality of terminal stations 3 while moving in the sky above the earth. The mobile relay station 2 accumulates data received from the terminal stations 3 via the terminal uplink signals, and wirelessly transmits the accumulated data to the base station 4 via downlink signals at a timing at which the mobile relay station 2 can communicate with the base station 4. The base station 4 acquires the data collected by the terminal stations 3 from the received downlink signals.

The mobile relay station 2 includes antennas used for wireless communication with the terminal stations 3 and antennas used for wireless communication with the base station 4. Therefore, the mobile relay station 2 can perform wireless communication with the terminal stations 3 and wireless communication with the base station 4 in parallel.

The mobile relay station may be, for example, a relay station mounted on an unmanned aerial vehicle such as a geostationary satellite, drone, or high altitude platform station (HAPS). However, a relay station mounted on a geostationary satellite has a wide coverage area (footprint) on the ground, but has an extremely small link budget with respect to IoT terminals installed on the ground because the altitude thereof is high. Meanwhile, a relay station mounted on a drone or HAPS has a high link budget, but has a narrow coverage area.

Further, the drone needs a battery, and the HAPS needs a solar panel. In the present embodiment, the mobile relay station 2 is mounted on the LEO satellite. Thus, the link budget falls within a limit, and, in addition, the LEO satellite has no air resistance and has low fuel consumption because the LEO satellite travels around the outside of the atmosphere. Further, the footprint is large, as compared with a case where the relay station is mounted on the drone or HAPS.

The terminal station 3 collects data such as environmental data detected by a sensor. The terminal station 3 is activated based on an activation signal transmitted from the mobile relay station 2, and wirelessly transmits collected data to the mobile relay station 2. For example, in a case where an instruction for a transmission timing is given from the mobile relay station 2, the terminal station 3 wirelessly transmits the collected data to the mobile relay station 2 at the transmission timing for which the instruction is given. The terminal station 3 is an aspect of a communication device.

The base station 4 receives the data collected by the terminal stations 3 from the mobile relay station 2.

The terminal station 3 and the base station 4 are installed at specific positions on the earth such as on the ground or on the sea.

A configuration of each device will be described.

The mobile relay station 2 includes one antenna 21, a terminal communication unit 22, a storage unit 23, a control unit 24, a base station communication unit 25, and one antenna 26. Note that the mobile relay station 2 may include a plurality of antennas 21. In such a configuration, the mobile relay station 2 performs reception processing by multiple-input and multiple-output (MIMO).

The terminal communication unit 22 includes a transmission/reception unit 221, a terminal signal demodulation unit 222, an activation signal generation unit 223, a distribution unit 224, frequency change application units 225-1 to 225-N (N is an integer of 1 or more), and a synthesizing unit 226. Note that, in a case where there is one frequency change application unit 225, the terminal communication unit 22 may not include the distribution unit 224 and the synthesizing unit 226.

The transmission/reception unit 221 receives a terminal uplink signal through the antenna 21. In this manner, the transmission/reception unit 221 communicates with one or more terminal stations 3 via the antenna 21.

The terminal signal demodulation unit 222 demodulates the terminal uplink signal received by the transmission/reception unit 221, and stores the demodulation result in the storage unit 23. For example, when the data collected by the terminal station 3 is included in the demodulation result, the terminal signal demodulation unit 222 stores the demodulation result in the storage unit 23.

The demodulation performed by the terminal signal demodulation unit 222 includes, for example, frequency conversion for converting a radio frequency (RF) signal received by the transmission/reception unit 221 into a baseband signal, and frame detection for detecting uplink signals transmitted from the terminal station 3. Furthermore, for example, in a case where the terminal signal demodulation unit 222 performs digital processing, the terminal signal demodulation unit 222 performs analog-to-digital conversion.

The activation signal generation unit 223 generates an activation signal for activating the plurality of terminal stations 3.

The distribution unit 224 distributes the activation signal generated by the activation signal generation unit 223.

The frequency change application units 225-1 to 225-N apply a frequency change to the activation signal distributed by the distribution unit 224. The frequency change application units 225-1 to 225-N are disposed in parallel and apply different frequency changes to the activation signals distributed by the distribution unit 224.

The synthesizing unit 226 synthesizes each activation signal to which the frequency change is applied to generate a synthesized activation signal.

The storage unit 23 stores at least orbit information 231, received data 232, and an application table 233. The orbit information 231 is information related to the orbit of the LEO satellite on which the mobile relay station 2 is mounted, and is, for example, information by which the position, speed, moving direction, and the like of the LEO satellite can be obtained at a random time. The received data 232 is data collected by the terminal station 3 and is data to be transmitted to the base station 4. The application table 233 is a table in which frequency change values to be applied by the frequency change application units 225-1 to 225-N are registered for each area.

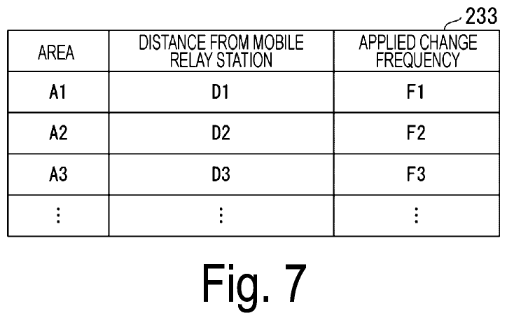

FIG. 7 is a diagram illustrating an example of the application table 233 according to the embodiment. The application table 233 has a plurality of records indicating information on the frequency change value applied to each area. The record has respective values of the area, the distance from the mobile relay station, and the applied change frequency. The value of the area represents a region determined according to the distance from the mobile relay station 2. The value of the distance from the mobile relay station indicates a distance from a reference position with a position immediately below the mobile relay station 2 as the reference position. The value of the applied change frequency is a frequency change value applied to the activation signal by the frequency change application units 225-1 to 225-N. The applied change frequency is 0 Hz/s or more. Here, the reason why the applied change frequency is set to 0 Hz/s or more is that activation may be possible depending on an area even when a frequency change value is not applied (even when the activation signal generated by the activation signal generation unit 223 remains). Therefore, by applying a value of 0 Hz/s that does not substantially change the frequency of the activation signal, it is possible to activate the terminal station 3 disposed in the activatable area without applying the frequency change value. The number of areas registered in the application table 233 is equal to or less than the number of frequency change application units 225-1 to 225-N.

In the example illustrated in FIG. 7, the applied change frequency for each area is associated with the application table 233. For example, the uppermost row of the application table 233 is associated with an area “A1”, a distance from the mobile relay station “D1”, and an applied change frequency “F1”. This indicates that a region which is the distance “D1” away from the reference position is the area “A1”, and the frequency change value applied to the activation signal to activate the terminal station 3 disposed in the area “A1” is “F1”.

As illustrated in FIG. 7, the application table 233 is associated with the frequency change value applied to the activation signal in order to activate the terminal station 3 disposed in each area. By applying these frequency change values to the activation signal, the terminal station 3 disposed in each area viewed from the reference position can be activated.

The control unit 24 includes a processor such as a central processing unit (CPU) and a memory. The control unit 24 implements the functions of an operation control unit 241 and a setting unit 242 by executing the program. Some or all of these functional units may be implemented by hardware (a circuit unit, including circuitry) such as an application specific integrated circuit (ASIC), a programmable logic device (PLD), or a field programmable gate array (FPGA), or by cooperation of software and hardware. Some of these functions need not be mounted on the mobile relay station 2 in advance, and may be implemented by installing an additional application program in the mobile relay station 2.

The operation control unit 241 refers to the orbit information 231 and the time information, and determines whether or not the place where the LEO satellite equipped with the mobile relay station 2 is currently located is in the sky above the data collection area. In the case of the data collection area, the operation control unit 241 instructs the setting unit 242 to acquire the frequency change value and instructs the terminal communication unit 22 to transmit the activation signal. On the other hand, when the area is not the data collection area, the operation control unit 241 does nothing in particular.

In response to the instruction from the operation control unit 241, the setting unit 242 refers to the application table 233 and sets the frequency change value applied by each frequency change application unit 225-n for each frequency change application unit 225-n. Specifically, first, the setting unit 242 reads the application table 233 from the storage unit 23. Next, the setting unit 242 refers to the read application table 233 and acquires the value of each applied change frequency for each area. The value of the applied change frequency is a value to be set in the frequency change application unit 225-n. The setting unit 242 sets the acquired values of each of the applied change frequencies for the respective areas in different frequency change application units 225-n. As a result, each frequency change application unit 225-n can apply different frequency change values.

The base station communication unit 25 reads the received data stored in the storage unit 23 from the data storage unit 23 as transmitted data to the base station 4. The base station communication unit 25 encodes and modulates the transmitted data and generates a base station downlink signal. The base station communication unit 25 transmits the base station downlink signal from the antenna 26.

The terminal station 3 includes a data storage unit 31, a transmission/reception unit 32, a demodulation unit 33, an activation control unit 34, and an antenna 35. In order to suppress power consumption, the terminal station 3 is in a sleep state except for some functions until receiving an activation signal from the mobile relay station 2. Here, some functions are, for example, the data storage unit 31, the transmission/reception unit 32, the demodulation unit 33, and the activation control unit 34 illustrated in FIG. 2. The terminal station 3 may include a plurality of antennas 35.

The data storage unit 31 stores environmental data detected by the sensor.

The transmission/reception unit 32 communicates with the mobile relay station 2. For example, the transmission/reception unit 32 receives a downlink signal transmitted from the mobile relay station 2. For example, the transmission/reception unit 32 reads environmental data from the data storage unit 31 as terminal transmitted data in response to an instruction from the communication control unit 33. The transmission/reception unit 32 wirelessly transmits the terminal uplink signal in which the read terminal transmitted data is set from the antenna 35.

The transmission/reception unit 32 transmits and receives signals by using low power wide area (LPWA), for example. LPWA includes LoRaWAN (registered trademark), Sigfox (registered trademark), Long Term Evolution for Machines (LTE-M), Narrow Band (NB)-IoT, and the like, but any wireless communication scheme may be used. The transmission/reception unit 32 may perform transmission and reception with another terminal station 3 by using time division multiplexing, orthogonal frequency division multiplexing (OFDM), or the like. The transmission/reception unit 32 may perform beam formation of signals transmitted from the plurality of antennas 35 according to a method determined in advance in the wireless communication scheme to be used.

The demodulation unit 33 demodulates the downlink signal received by the transmission/reception unit 32. The downlink signal received by the transmission/reception unit 32 is a signal obtained by synthesizing an activation signal to which different frequency conversions are applied and an activation signal to which no frequency conversion is applied. A Doppler shift occurs in the downlink signal according to the distance between the mobile relay station 2 and the terminal station 3.

The activation control unit 34 changes the sleep state to the activated state according to the activation signal included in the downlink signal demodulated by the demodulation unit 33.

The base station 4 includes an antenna 41. The base station 4 converts the terminal downlink signal received by the antenna 41 into an electrical signal, and then performs demodulation and decoding to obtain received waveform information. The base station 4 performs reception processing for the terminal uplink signal indicated by the received waveform information. At this time, the base station 4 acquires terminal transmitted data by performing reception processing according to the wireless communication scheme used for transmission by the terminal station 3.

An operation of the wireless communication system 1 will be described.

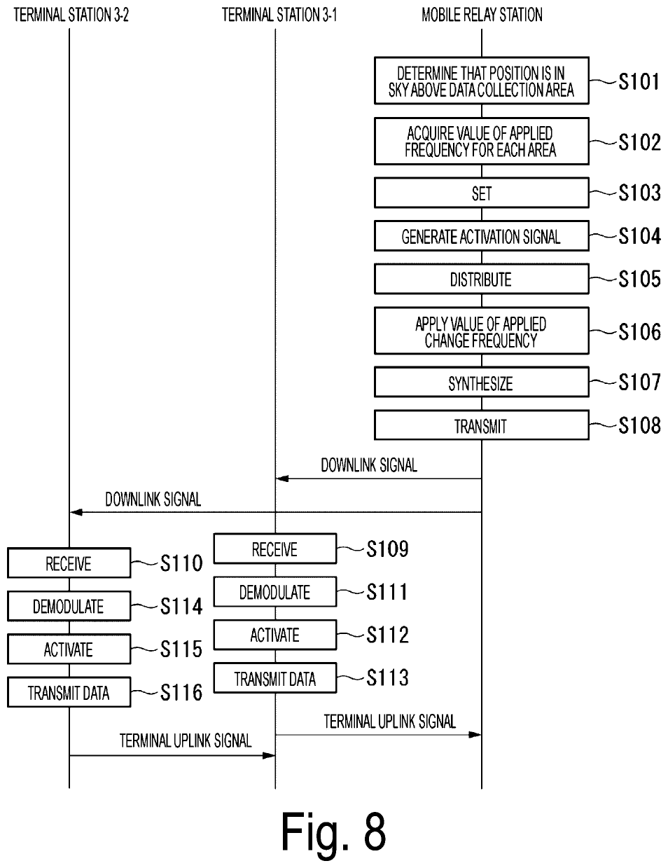

FIG. 8 is a sequence diagram illustrating a flow of activation processing in the terminal station 3 performed by the wireless communication system 1 according to the embodiment. In the example illustrated in FIG. 8, it is assumed that the terminal station 3-1 is disposed in the area A1 and the terminal station 3-2 is disposed in the area A2.

The operation control unit 241 determines that the current position of the mobile relay station 2 is in the sky above the data collection area (step S101). The operation control unit 241 instructs the setting unit 242 to acquire the frequency change value, and instructs the terminal communication unit 22 to transmit the activation signal. In response to the instruction from the operation control unit 241, the setting unit 242 refers to the application table 233 and acquires the value of the applied change frequency (for example, the applied change frequency “F1”, “F2”, . . . ) for each area (for example, the areas “A1”, “A2”, . . . ) (step S102).

The setting unit 242 sets the acquired value of the applied change frequency for each area in each frequency change application unit 225-n (step S103). For example, the setting unit 242 sets the acquired value “F1” of the applied change frequency of the area “A1” in the frequency change application unit 225-1, and sets the acquired value “F2” of the applied change frequency of the area “A2” in the frequency change application unit 225-2.

The activation signal generation unit 223 generates an activation signal in response to an instruction from the operation control unit 241 (step S104). The activation signal generation unit 223 outputs the generated activation signal to the distribution unit 224. The distribution unit 224 receives the activation signal. The activation signal input to the distribution unit 224 is distributed (step S105). As a result, the activation signal is input to each frequency change application unit 225.

Each frequency change application unit 225 applies the value of the applied change frequency set by the setting unit 242 to the input activation signal (step S106). Each frequency change application unit 225 outputs an activation signal to which a value of the applied change frequency is applied to the synthesizing unit 226. The activation signal output from each frequency change application unit 225-n is input to the synthesizing unit 226.

The synthesizing unit 226 synthesizes each of the input activation signals to generate a synthesized activation signal (step S107). The synthesizing unit 226 outputs the generated synthesized activation signal to the transmission/reception unit 221. The transmission/reception unit 221 transmits the synthesized activation signal output from the synthesizing unit 226 as a downlink signal via the antenna 21 (step S108). The downlink signal transmitted from the mobile relay station 2 is received by the terminal stations 3-1 and 3-2 located within the coverage of radio waves transmitted from the mobile relay station 2 (steps S109 and S110).

The transmission/reception unit 32 of the terminal station 3-1 outputs the received downlink signal to the demodulation unit 33. The demodulation unit 33 of the terminal station 3-1 demodulates the downlink signal (step S111). Here, the downlink signal includes a plurality of activation signals to which different frequency changes are applied. Although the signals to which different frequency changes are applied interfere with each other, due to the in-frame Doppler shift, only the signal after application of the frequency change suitable for the area is emphasized, and the signal after application of other frequency changes is frequency-spread. The demodulation unit 33 of the terminal station 3-1 disposed in the area “A1” can demodulate the activation signal to which the applied change frequency “F1” is applied.

The activation control unit 34 of the terminal station 3-1 performs control to change the sleep state to the activated state based on the activation signal demodulated by the demodulation unit 33 (step S112). The transmission/reception unit 32 of the terminal station 3-1 transmits a terminal uplink signal based on the environmental data stored in the data storage unit (step S113).

The transmission/reception unit 32 of the terminal station 3-2 outputs the received downlink signal to the demodulation unit 33. The demodulation unit 33 of the terminal station 3-2 demodulates the downlink signal (step S114). The demodulation unit 33 of the terminal station 3-2 disposed in the area “A2” can demodulate the activation signal to which the applied change frequency “F2” is applied. The activation control unit 34 of the terminal station 3-2 performs control to change the sleep state to the activated state based on the activation signal demodulated by the demodulation unit 33 (step S115). The transmission/reception unit 32 of the terminal station 3-2 transmits a terminal uplink signal based on the environmental data stored in the data storage unit (step S116).

As a result, the mobile relay station 2 can receive the terminal uplink signal transmitted from each terminal station 3. While being in the sky above the data collection area, the mobile relay station 2 repeatedly executes the processing from step S102 to step S108.

According to the wireless communication system 1 configured as described above, the mobile relay station 2 applies a frequency change to the activation signal, and transmits the activation signal to which the frequency change is applied. As a result, even when a Doppler shift occurs in the activation signal received by the terminal station 3 installed on the ground, since a frequency change suitable for the area is applied, the activation signal is emphasized by the Doppler shift. Therefore, the terminal station 3 can demodulate the activation signal. As a result, the terminal station 3 can be activated. As described above, in the wireless communication system 1, even when a Doppler shift occurs in a signal transmitted from the mobile relay station 2 moving in the sky, the terminal station 3 installed on the ground can be activated.

Further, in the wireless communication system 1, the activation signal generated by the activation signal generation unit 223 is distributed by the distribution unit 224 and output to each of the plurality of frequency change application units 225, and the activation signals to which frequency changes are applied by the plurality of frequency change application units 225 are synthesized by the synthesizing unit 226 and then transmitted. As a result, it is possible to synthesize and transmit the activation signals to which a plurality of frequency changes are applied. Although the activation signals to which different frequency changes are applied interfere with each other, due to the in-frame Doppler shift, in the orbit signals received by the terminal stations 3 disposed in each area, only the activation signal after application of the frequency change suitable for the area is emphasized, and the activation signal after application of other frequency changes is frequency-spread. Therefore, the terminal station 3 disposed in each area can demodulate the activation signal and can activate the terminal station 3.

Hereinafter, a modification example of the wireless communication system 1 will be described.

In the above-described embodiment, the configuration has been described in which the mobile relay station 2 determines whether or not the mobile relay station 2 is in the sky above the data collection area based on the orbit information 231 and the time information. The mobile relay station 2 may be configured to determine whether or not the mobile relay station 2 is in the sky above the data collection area by another method. Specifically, the mobile relay station 2 may grasp a start time and an end time at which data is collected from the terminal station 3 by uplink communication from the base station 4, and determine that the mobile relay station 2 is in the sky above the data collection area from the start time to the end time.

In the above-described embodiment, the configuration has been described in which the mobile relay station 2 is activates the terminal stations 3 disposed in each area within the coverage of radio waves. The mobile relay station 2 may be configured to activate the terminal station 3 disposed in a specific area. As illustrated in FIG. 7, the value of the applied change frequency for each area is registered in the application table 233. Therefore, the mobile relay station 2 only needs to apply, to the activation signal, only the value of the applied change frequency corresponding to the area in which the terminal station 3 is desired to be activated, and transmit the activation signal. Specifically, first, when an instruction to activate the terminal station 3 installed in a specific area is input, the setting unit 242 refers to the application table 233 and acquires the value of the applied change frequency corresponding to the specific area. For example, when the specific area is one area, the setting unit 242 refers to the application table 233 and acquires the value of the applied change frequency corresponding to one specific area. Next, the setting unit 242 sets the acquired values of the applied change frequency in all the frequency change application units 225. As a result, the synthesized activation signal generated by the synthesizing unit 226 includes the activation signal to which only the value of the applied change frequency corresponding to the specific area is applied. Then, the transmission/reception unit 221 transmits the generated synthesized activation signal. As a result, the activation signal for a specific area is more emphasized. As a result, the terminal station 3 disposed in a specific area can demodulate and decode the activation signal more reliably. As a result, only the terminal station 3 disposed in the specific area can be activated. Therefore, the terminal station 3 that does not need to be activated is not activated, and power consumption can be suppressed. Note that the number of specific areas may be one or more. For example, when the specific area is two areas (for example, the areas A1 and A2), the setting unit 242 refers to the application table 233 and acquires each of the values of the applied change frequencies corresponding to the two specific areas. Next, the setting unit 242 sets each value of the acquired applied change frequency in the frequency change application unit 225. At this time, the setting unit 242 may uniformly set each acquired value of the applied change frequency in the frequency change application unit 225, or may set each value at a predetermined ratio. When the number of frequency change application units 225 is four and each acquired value of the applied change frequency is uniformly set in the frequency change application unit 225, the setting unit 242 may set the value of the applied change frequency corresponding to the area A1 in the frequency change application units 225-1 to 2, and may set the value of the applied change frequency corresponding to the area A2 in the frequency change application units 225-3 to 4. When the number of frequency change application units 225 is four and each acquired value of the applied change frequency is set in the frequency change application unit 225 at a predetermined ratio (for example, the ratio between the area A1 and the area A2 is 3:1), the setting unit 242 may set the value of the applied change frequency corresponding to the area A1 in the frequency change application units 225-1 to 3, and may set the value of the applied change frequency corresponding to the area A2 in the frequency change application unit 225-4 according to the ratio.

In the above-described embodiment, the configuration has been described in which the frequency change application unit 225 applies a value of 0 Hz/s to the activation signal in order for the mobile relay station 2 to activate the terminal station 3 disposed in the activatable area without applying the frequency change value. In this case, the N frequency change application units 225 are required to apply frequency change values to the respective activation signals distributed to the N paths by the distribution unit 224. On the other hand, the mobile relay station 2 may include (N−1) frequency change application units 225, and one of the N paths distributed by the distribution unit 224 may be configured to be a path directly connecting the distribution unit 224 and the synthesizing unit 226 (a path not passing through the frequency change application unit 225). That is, the mobile relay station 2 may be configured such that (N−1) frequency change application units 225 apply frequency change values to (N−1) activation signals among the activation signals (N activation signals) distributed to N paths by the distribution unit 224, and one activation signal is directly input to the synthesizing unit 226. In this case, (N−1) frequency change application units 225 apply frequency application values other than 0. Then, the activation signal distributed by the distribution unit 224 and directly input to the synthesizing unit 226 is an activation signal for activating the terminal station 3 disposed in an area where activation is possible without applying a frequency change value.

With such a configuration, the configuration of the mobile relay station 2 can be reduced as compared with the configuration of the above-described embodiment.

In the above embodiments, there has been described a case where a moving object equipped with the mobile relay station is the LEO satellite. However, the moving object may be another flying object flying in the sky, such as a geostationary satellite, drone, or HAPS.

A part or the entirety of the processing performed by the mobile relay station 2 in the above-described embodiments may be implemented by a computer. In that case, a program for implementing this function may be recorded in a computer-readable recording medium, and the program recorded in the recording medium may be read and executed by a computer system to implement the functions. Note that the “computer system” mentioned herein includes an OS and hardware such as peripheral devices. In addition, the “computer-readable recording medium” refers to a portable medium such as a flexible disk, a magneto-optical disc, a ROM, or a CD-ROM, or a storage device such as a hard disk built in a computer system.

Furthermore, the “computer-readable recording medium” may include a medium that dynamically holds a program for a short time, such as a communication line in a case where the program is transmitted via a network such as the Internet or a communication line such as a telephone line, and a medium that holds a program for a certain period of time, such as a volatile memory inside a computer system serving as a server or a client in that case. Also, the above program may be for implementing some of the functions described above, may be for implementing the functions described above in combination with programs already recorded in the computer system, or may be implemented with a programmable logic device such as a field programmable gate array (FPGA).

Although the embodiments of the present invention have been described above in detail with reference to the drawings, the specific configuration is not limited to the embodiments, and includes design and the like without departing from the spirit of the present invention.

### INDUSTRIAL APPLICABILITY

The present invention can be applied to a technology for performing communication with a moving object equipped with a mobile relay station.

### REFERENCE SIGNS LIST

1 Wireless communication system
2 Mobile relay station
3 Terminal station
4 Base station
21 Antenna
22 Terminal communication unit
23 Storage unit
24 Control unit
25 Base station communication unit
26 Antenna
31 Data storage unit
32 Transmission/reception unit
33 Demodulation unit
34 Demodulation unit
35 Antenna
41 Antenna
221 Transmission/reception unit
222 Terminal signal demodulation unit
223 Activation signal generation unit
224 Distribution unit
225-1 to 225-N Frequency change application unit
226 Synthesizing unit
241 Operation control unit
242 Setting unit

1. A wireless communication device in a wireless communication system including one or more communication devices installed on the ground and a moving wireless communication device, the wireless communication device comprising:
an activation signal generator configured to generate an activation signal for activating the one or more communication devices;
one or more frequency change appliers configured to apply a frequency change to the activation signal generated by the activation signal generator; and
a transmitter configured to transmit an activation signal to which a frequency change is applied to the one or more frequency change appliers.

2. The wireless communication device according to claim 1, wherein
the one or more frequency change appliers are a plurality of frequency change appliers,
the wireless communication device further comprises:
a distributor configured to distribute the activation signal generated by the activation signal generator and outputs the activation signal to each of the plurality of frequency change-appliers; and
a synthesizer configured to synthesize each activation signal to which the frequency change is applied by the plurality of frequency change appliers, and
the transmitter transmission unit transmits the activation signal synthesized by the synthesizer.

3. The wireless communication device according to claim 2, wherein
each of the plurality of frequency change appliers applies a different frequency change to the activation signal distributed by the distributor.

4. The wireless communication device according to claim 2, wherein
at least some of the plurality of frequency change appliers apply the same frequency change to the activation signal distributed by the distributor.

5. The wireless communication device according to claim 1, further comprising: a setter configured to set a frequency change value applied by the one or more frequency change appliers for each of the one or more frequency change-appliers, wherein
the setter sets a frequency change value set for each area on the ground viewed from the wireless communication device for each of the one or more frequency change appliers.

6. The wireless communication device according to claim 5, wherein
when an instruction to activate the one or more communication devices installed in a specific area is input, the setter sets a frequency change value corresponding to the specific area in the one or more frequency change appliers.

7. An activation method performed by a wireless communication device in a wireless communication system including one or more communication devices installed on the ground and the moving wireless communication device, the activation method comprising:
generating an activation signal for activating the one or more communication devices;
applying a frequency change to the generated activation signal; and
transmitting an activation signal to which a frequency change is applied.
